(19) United States
(12) Patent Application Publication
(10) Pub. No.: US 2023/0300950 A1
(43) Pub. Date: Sep. 21, 2023

(54) WAX HEATER

(71) Applicant: Shenzhen Hezhongren E-Commerce Co., Ltd., Shenzhen (CN)

(72) Inventor: YI SHEN, Xiangxiang (CN)

(21) Appl. No.: 17/698,965

(22) Filed: Mar. 18, 2022

(51) Int. Cl. H05B 3/00

(52) U.S. Cl. CPC H05B 3/0014

(57) ABSTRACT

A wax heater comprising a housing, a wax guiding tube and a liner located within the housing. A closed interlayer is formed between the housing and the liner, the top of the liner is provided with an opening, and the liner is configured to contain solid wax; the closed interlayer is provided with a heating tube, the closed interlayer contains an insulating liquid, the heating tube is configured to heat the insulating liquid in the closed interlayer to boiling point, the boiling point of the insulating liquid is higher than the melting point of the solid wax; one end of the wax guide tube is connected to the liner, the other end of the wax guide tube passes through the closed interlayer and the housing and extends outside the housing; after the solid wax is melted, it flows out of the wax heater through the wax guide tube.

### TECHNICAL FIELD

The present application relates to the technical field of wax heaters, and in particular, to a wax heater.

### BACKGROUND

A wax heater is a heating device used to melt solid wax into a liquid. Usually, the solid wax is put into a container and heated by a heating device such as an electric heating tube. When the temperature reaches 60° C. and above, the wax will melt. The liquid wax is then discharged.

The traditional wax heater has the following technical problems: when the wax heater is working, the temperature is not well controlled and easily exceeds 100° C., thereby affecting the quality of the wax. During the wax discharge process, the liquid wax may become solid again because the temperature drops below 60° C., thereby blocking the wax discharge port. Such wax heaters cannot achieve uniform heating, are inefficient, and waste energy.

### SUMMARY

The present application aims to solve at least one of the above technical problems. By providing a wax heater, the quality of wax is not affected, the wax discharge port is not blocked, and the heating efficiency can be improved.

One aspect of the present application provides a wax heater, wherein the wax heater comprises a housing, a wax guiding tube and a liner located within the housing, a closed interlayer is formed between the housing and the liner, the top of the liner is provided with an opening, and the liner is configured to contain solid wax;
the closed interlayer is provided with a heating tube, the closed interlayer contains an insulating liquid, the heating tube is configured to heat the insulating liquid in the closed interlayer to boiling point, the boiling point of the insulating liquid is higher than the melting point of the solid wax;
one end of the wax guide tube is connected to the liner, the other end of the wax guide tube is configured to pass through the closed interlayer and the housing and to extend outside the housing;
after the solid wax is melted, it flows out of the wax heater through the wax guiding pipe.

Alternatively, one end of the wax guiding tube is configured to communicate with the liner at the bottom of the liner, and the other end of the wax guiding tube is provided with a wax discharger valve, the height of the wax discharge valve is lower than the bottom surface of the liner.

Alternatively, an upper cover is provided on the top of the liner, and the upper cover is configured to cover the opening.

Alternatively, an L-shaped water inlet pipe is provided on the side wall of the housing, and the first end of the L-shaped water inlet pipe is configured to pass through the housing to communicate with the top of the closed interlayer, and the height of the second end of the L-shaped water inlet pipe is higher than the height of the top of the closed interlayer.

Alternatively, a funnel is connected to the second end of the L-shaped water inlet pipe, and the funnel is configured for water intake.

Alternatively, a water inlet valve is connected between the funnel and the second end of the L-shaped water inlet pipe.

Alternatively, a water outlet pipe is provided on the side wall of the housing, the first end of the water outlet pipe is connected to the closed interlayer, and the water outlet pipe is provided with a drain valve, the second end of the water outlet pipe is configured to protrude, and the height of the second end of the water outlet pipe is lower than the height of the first end of the water outlet pipe.

Alternatively, the height of the first end of the water outlet pipe is lower than the bottom surface of the liner.

Alternatively, the side wall of the housing is further provided with an interface, the interface is configured to electrically connect with the heating tube, and the interface is configured to connect a power source to supply power to the heating tube.

Alternatively, the bottom of the housing is provided with a plurality of feet.

In the wax heater according to the present application, the wax heater comprising a housing, a wax guiding tube and a liner located within the housing. A closed interlayer is formed between the housing and the liner, the top of the liner is provided with an opening, and the liner is configured to contain solid wax; the closed interlayer is provided with a heating tube, the closed interlayer contains an insulating liquid, the heating tube is configured to heat the insulating liquid in the closed interlayer to boiling point, the boiling point of the insulating liquid is higher than the melting point of the solid wax; one end of the wax guide tube is connected to the liner, the other end of the wax guide tube passes through the closed interlayer and the housing and extends outside the housing; after the solid wax is melted, it flows out of the wax heater through the wax guide tube. When the wax heater is working, the heating tube heats the insulating liquid to heat the liner. When the temperature in the liner exceeds 60° C. of the melting point of the solid wax, the solid wax melts and flows out through the wax guiding tube. Since the closed interlayer surrounds the liner, the wax heater can uniformly heat the liner and improve the heating efficiency. When the temperature of the insulating liquid in the inner reaches the boiling point, it will not increase, so as to avoid the too high temperature affecting the quality of the wax. Since the wax guiding tube passes through the closed interlayer, during the wax discharge process, the temperature of the wax guiding tube will not drop below 60° C., and the liquid wax will not block the wax discharge port.

Further, one end of the wax guiding tube is communicated with the liner at the bottom of the liner, and the other end of the wax guiding tube is provided with a wax discharge valve, and the height of the wax discharge valve is lower than the bottom surface of the liner. The wax guide tube discharges wax from the bottom of the liner, and the position of the wax discharge valve is low, and the liquid wax can be completely discharged.

### BRIEF DESCRIPTION OF DRAWINGS

FIG. 1 is a schematic diagram of the overall structure of an embodiment of a wax heater according to the present application;

FIG. 2 is a first partial cross-sectional structural schematic diagram of an embodiment of the wax heater according to the present application;

FIG. 3 is a second partial cross-sectional structural schematic diagram of an embodiment of the wax heater according to the present application;

FIG. 4 is a third partial cross-sectional structural schematic diagram of an embodiment of the wax heater according to the present application;

FIG. 5 is a fourth partial cross-sectional structural schematic diagram of an embodiment of the wax heater according to the present application;

FIG. 6 is a first side structural schematic diagram of an embodiment of the wax heater according to the present application;

FIG. 7 is a second side structural schematic diagram of an embodiment of the wax heater according to the present application;

FIG. 8 is a third side structural schematic diagram of an embodiment of the wax heater according to the present application;

FIG. 9 is a fourth side structural schematic diagram of an embodiment of the wax heater according to the present application;

FIG. 10 is a schematic top-view structural diagram of an embodiment of the wax heater according to the present application;

FIG. 11 is a schematic bottom view of an embodiment of a wax heater according to a the present application;

FIG. 12 is a schematic structural diagram of the wax heater according to the present application when it is heated;

FIG. 13 is a schematic top-view structural diagram of another embodiment of the wax heater according to present application;

FIG. 14 is a schematic cross-sectional structure diagram of another embodiment of the wax heater according to the present application;

FIG. 15 is a schematic top-view structural diagram of another embodiment of the wax heater according to the present application;

FIG. 16 is a schematic top-view structural diagram of another embodiment of the wax heater according to the present application;

FIG. 17 is a schematic top-view structural diagram of another embodiment of the wax heater according to the present application;

FIG. 18 is a schematic top-view structural diagram of another embodiment of the wax heater according to the present application;

FIG. 19 is a schematic top view of the structure of another embodiment of the wax heater according to the present application.

### DETAILED DESCRIPTION

The technical solutions in the embodiments of the present application will be clearly and completely described below with reference to the drawings in the embodiments of the present application. Obviously, the described embodiments are only a part of the embodiments of the present application, rather than all the embodiments. Based on the embodiments in the present application, all other embodiments obtained by those skilled in the art without creative work fall within the protection scope of the present application.

In the description of the present application, it should be noted that the terms “center”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, etc. which are used to indicate position or positional relationship are based on the position or positional relationship shown in the drawings, and are only for the convenience of describing the application and simplifying the description, rather than indicating or implying that the indicated position or element must have a specific orientation and be constructed in a specific orientation and operation, therefore cannot be understood as a limitation of the present application. In addition, the terms “first” and “second” are only used for descriptive purposes, and should not be construed as indicating or implying relative importance or implying the number of indicated technical features. Thus, features defined as “first”, “second” may expressly or implicitly include one or more features. In the description of the present application, “plurality” means two or more, unless otherwise expressly and specifically defined.

In this application, the word “exemplary” is used to mean “serving as an example, or illustration.” Any embodiment described in this application as “exemplary” is not necessarily to be construed as preferred or advantageous over other embodiments. The following description is presented to enable any person skilled in the art to make and use the present application. In the following description, details are set forth for the purpose of explanation. It is to be understood that one of ordinary skill in the art can realize that the present application may be practiced without the use of these specific details. In other instances, well-known structures and procedures have not been described in detail so as not to obscure the description of the present application with unnecessary detail. Therefore, this application is not intended to be limited to the embodiments shown but is to be accorded the widest scope consistent with the principles and features disclosed herein.

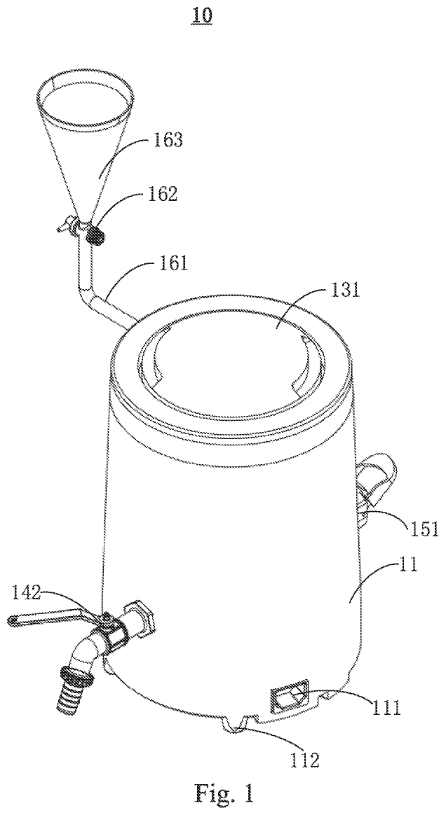

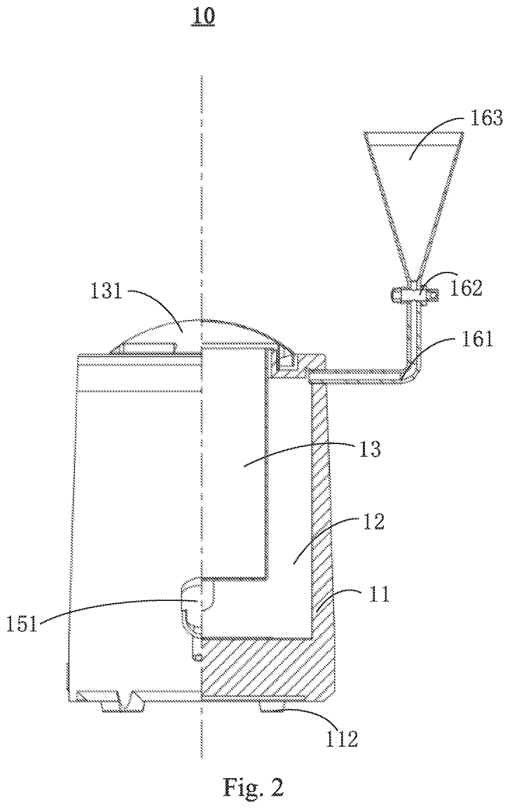

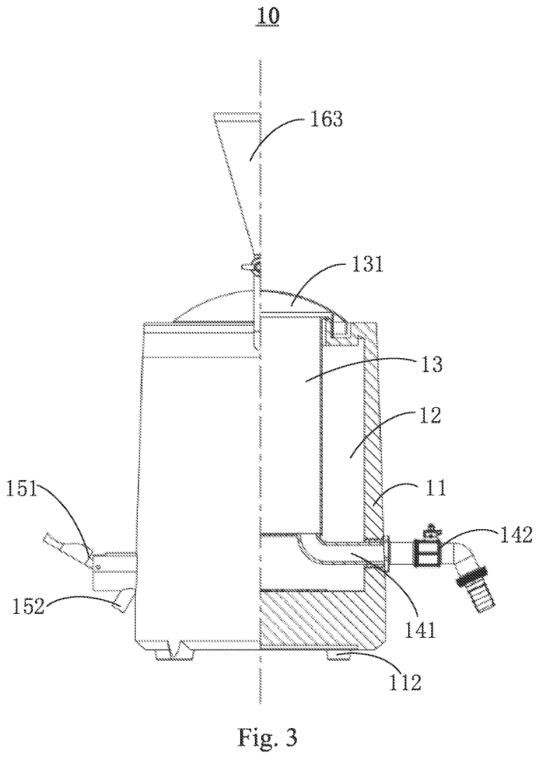

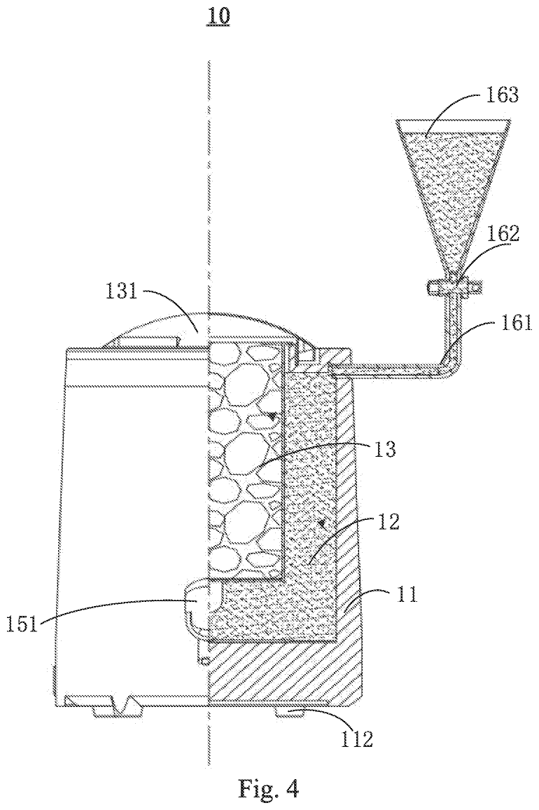

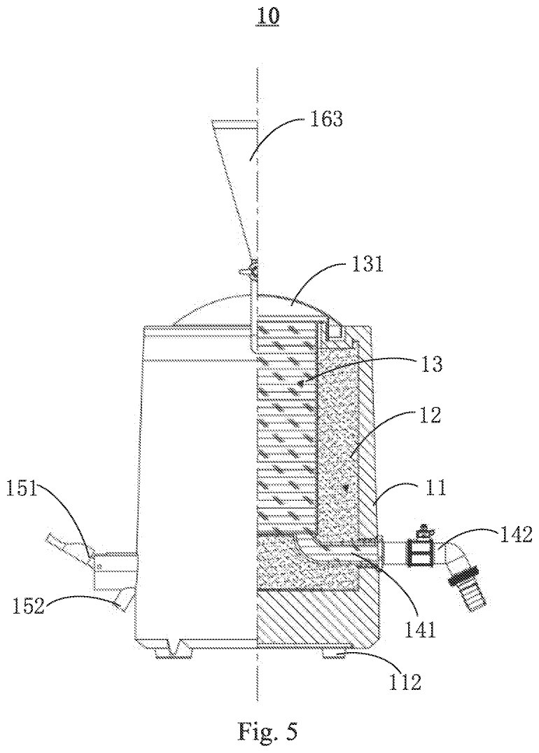

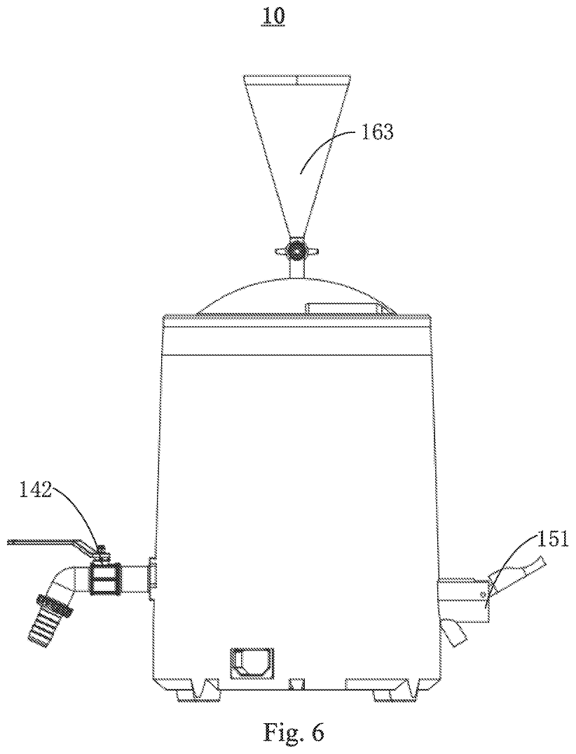

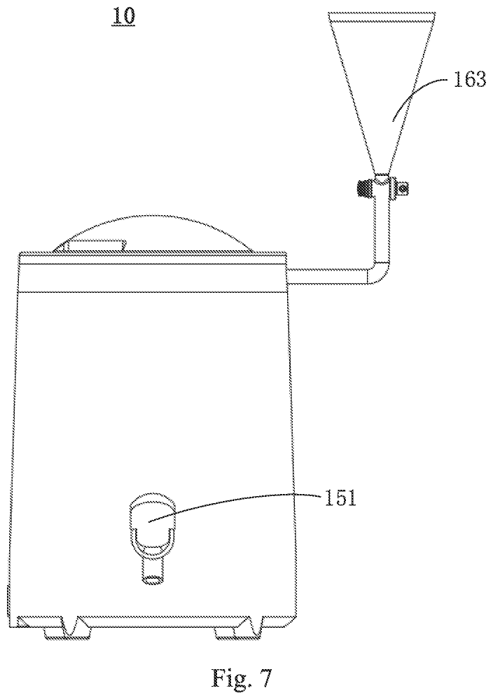

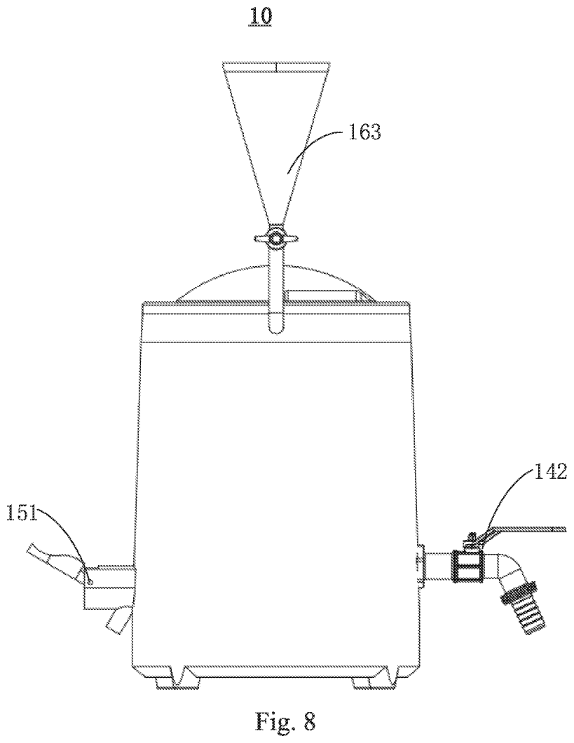

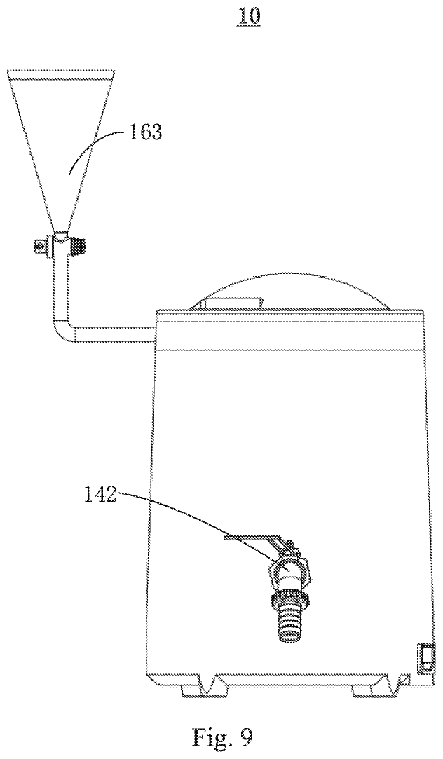

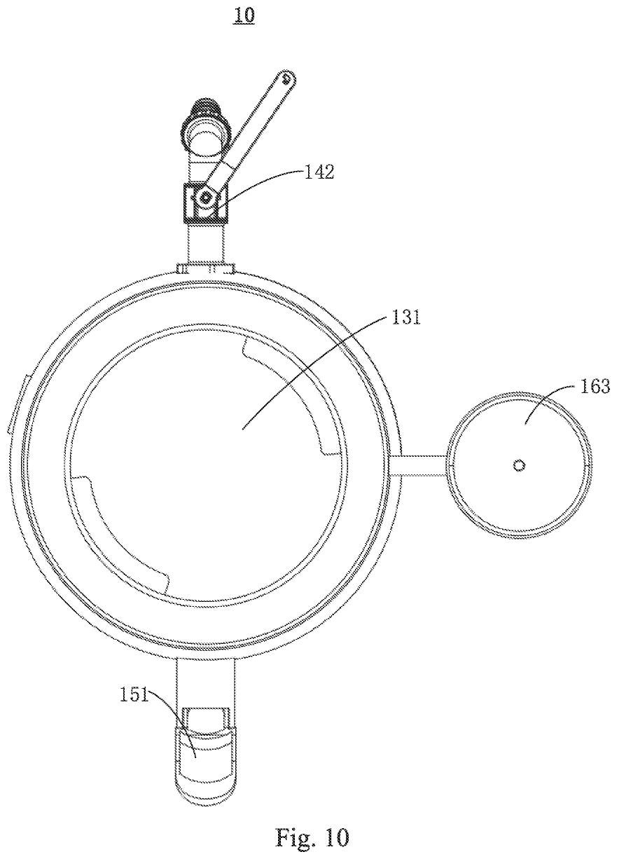

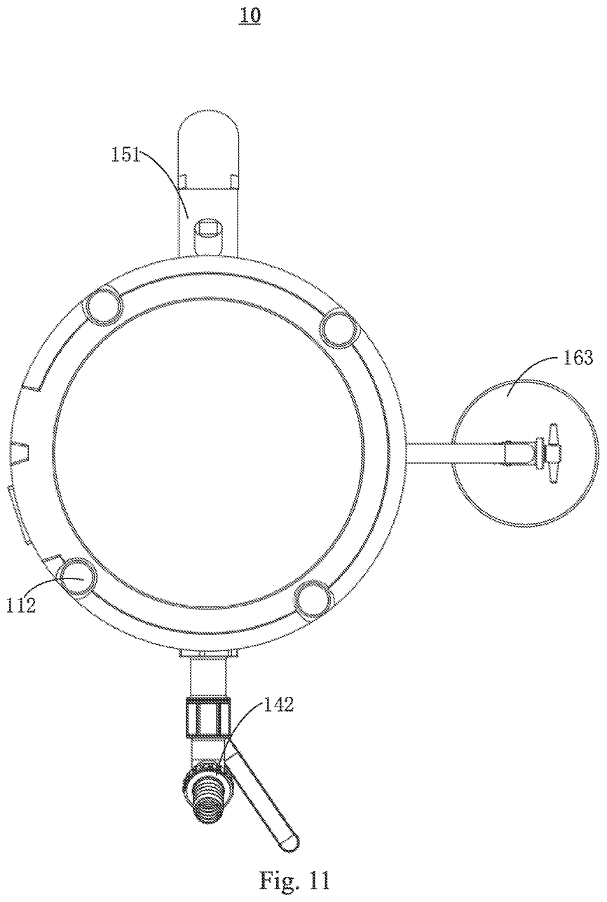

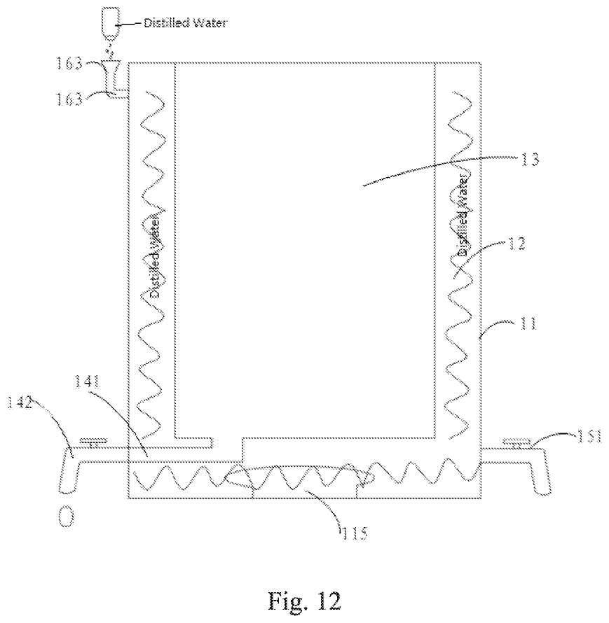

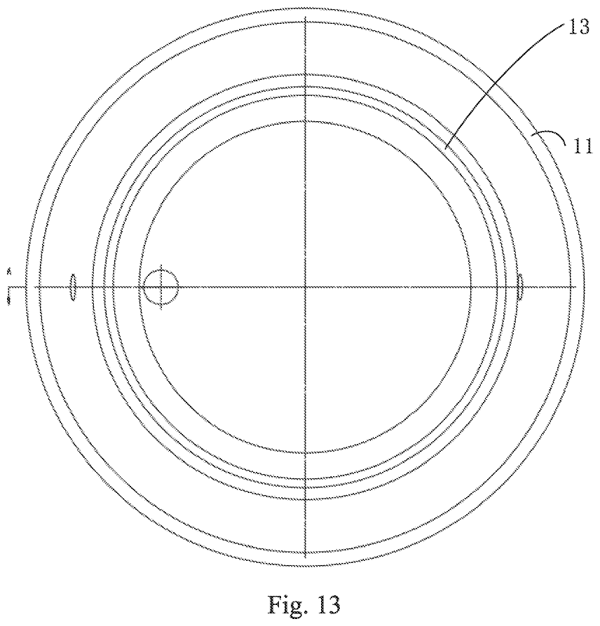

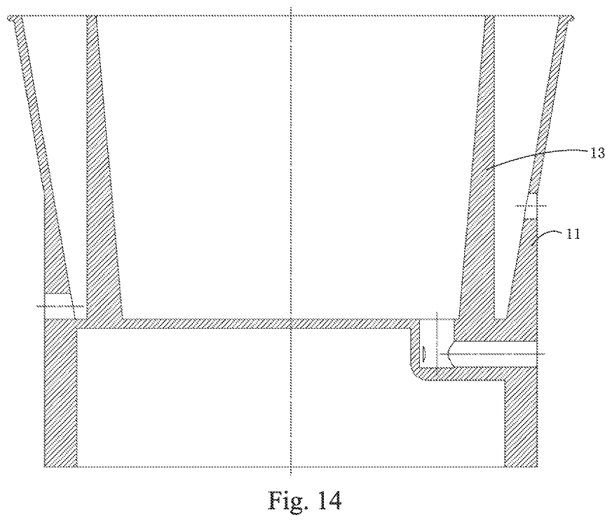

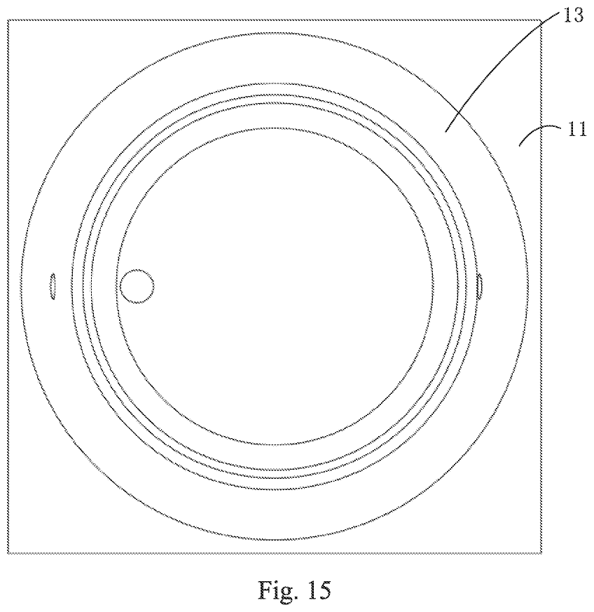

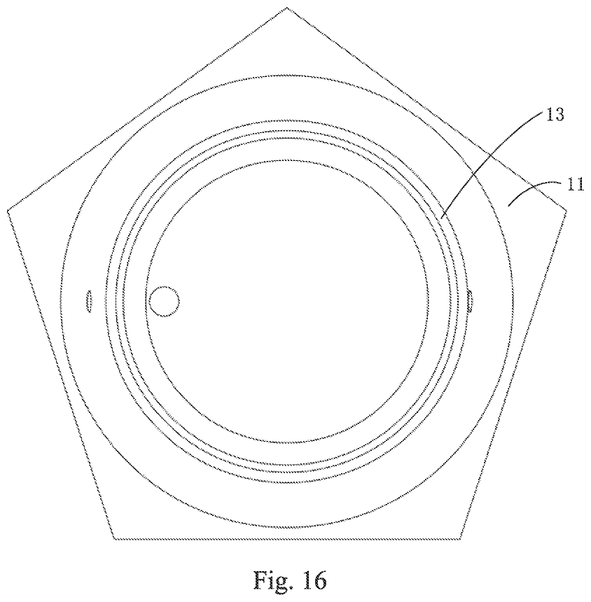

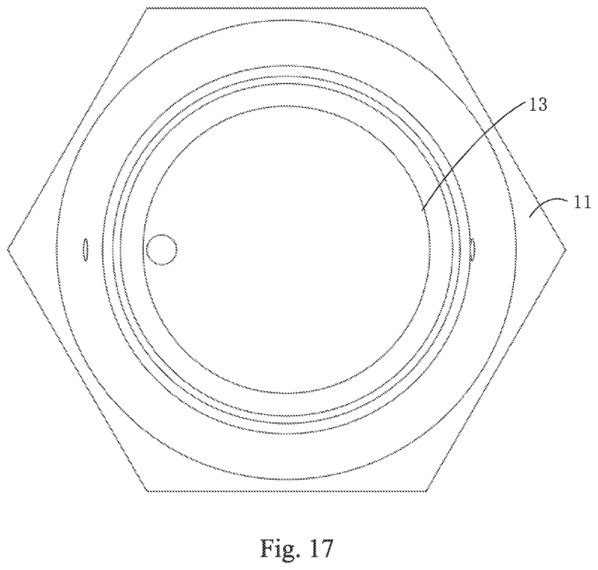

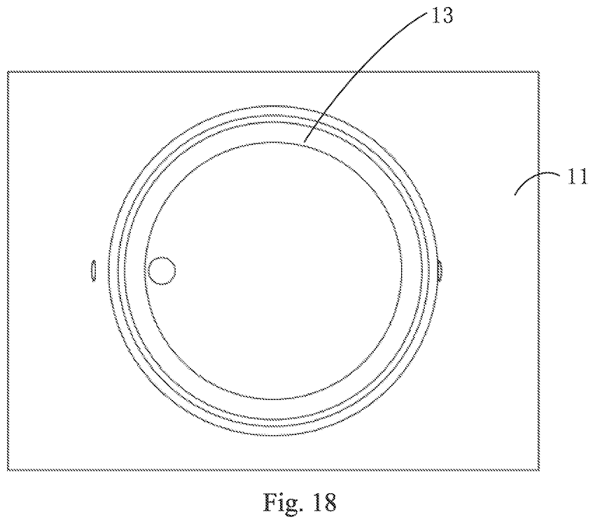

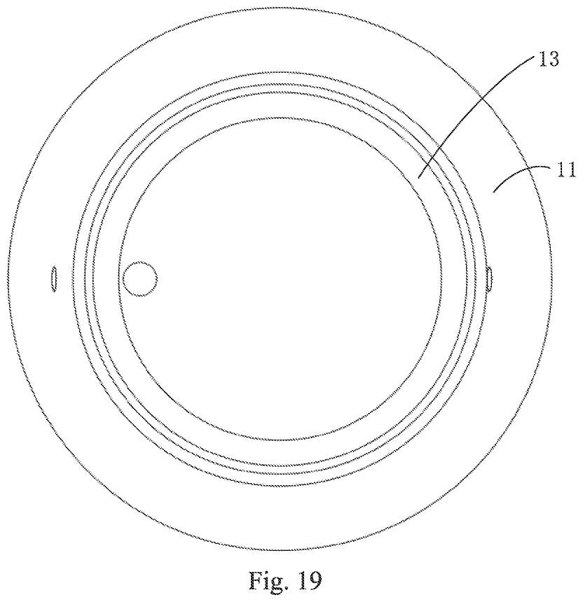

Refer to FIGS. 1-19, FIG. 1 is a schematic diagram of the overall structure of an embodiment of a wax heater according to the present application; FIG. 2 is a first partial cross-sectional structural schematic diagram of an embodiment of the wax heater according to the present application; FIG. 3 is a second partial cross-sectional structural schematic diagram of an embodiment of the wax heater according to the present application; FIG. 4 is a third partial cross-sectional structural schematic diagram of an embodiment of the wax heater according to the present application; FIG. 5 is a fourth partial cross-sectional structural schematic diagram of an embodiment of the wax heater according to the present application; FIG. 6 is a first side structural schematic diagram of an embodiment of the wax heater according to the present application; FIG. 7 is a second side structural schematic diagram of an embodiment of the wax heater according to the present application; FIG. 8 is a third side structural schematic diagram of an embodiment of the wax heater according to the present application; FIG. 9 is a fourth side structural schematic diagram of an embodiment of the wax heater according to the present application; FIG. 10 is a schematic top-view structural diagram of an embodiment of the wax heater according to the present application; FIG. 11 is a schematic bottom view of an embodiment of a wax heater according to a the present application; FIG. 12 is a schematic structural diagram of the wax heater according to the present application when it is heated; FIG. 13 is a schematic top-view structural diagram of another embodiment of the wax heater according to present application; FIG. 14 is a schematic cross-sectional structure diagram of another embodiment of the wax heater according to the present application; FIG. 15 is a schematic top-view structural diagram of another embodiment of the wax heater according to the present application; FIG. 16 is a schematic top-view structural diagram of another embodiment of the wax heater according to the present application; FIG. 17 is a schematic top-view structural diagram of another embodiment of the wax heater according to the present application; FIG. 18 is a schematic top-view structural diagram of another embodiment of the wax heater according to the present application; FIG. 19 is a schematic top view of the structure of another embodiment of the wax heater according to the present application.

According to the embodiment of the present application, the wax heater 10 comprises a housing 11, a wax guiding tube 141 and a liner 13 located within the housing 11. A closed interlayer 12 is formed between the housing 11 and the liner 13, the top of the liner 13 is provided with an opening, and the liner 13 is configured to contain solid wax; the closed interlayer 12 is provided with a heating tube 115, the closed interlayer 12 contains an insulating liquid, the heating tube 115 is configured to heat the insulating liquid in the closed interlayer 12 to boiling point, the boiling point of the insulating liquid is higher than the melting point of the solid wax; one end of the wax guide tube 141 is connected to the liner 13, the other end of the wax guide tube 141 passes through the closed interlayer 12 and the housing 11 and extends outside the housing 11; after the solid wax is melted, it flows out of the wax heater 10 through the wax guide tube 141.

When the wax heater 10 is working, the heating tube 115 heats the insulating liquid to heat the liner 13. When the temperature in the liner 13 exceeds 60° C. of the melting point of the solid wax, the solid wax melts and flows out through the wax guiding tube 141. Since the closed interlayer 12 surrounds the liner 13, the wax heater can uniformly heat the liner 13 and improve the heating efficiency. When the temperature of the insulating liquid in the inner 13 reaches the boiling point, it will not increase, so as to avoid the too high temperature affecting the quality of the wax. Since the wax guiding tube 141 passes through the closed interlayer 12, during the wax discharge process, the temperature of the wax guiding tube 141 will not drop below 60° C., and the liquid wax will not block the wax discharge port.

According to the embodiment of the present application, one end of the wax guiding tube 141 is communicated with the liner 13 at the bottom of the liner 13, and the other end of the wax guiding tube 141 is provided with a wax discharge valve 142, and the height of the wax discharge valve 142 is lower than the bottom surface of the liner 13. The wax guide tube 141 discharges wax from the bottom of the liner 13, and the position of the wax discharge valve 142 is low, and the liquid wax can be completely discharged.

According to the embodiment of the present application, the top of the liner 13 is provided with an upper cover 131, and the upper cover 131 is used to cover the opening. The liner 13 is covered by the upper cover 131 to avoid heat dissipation and improve the heating efficiency.

According to the embodiment of the present application, an L-shaped water inlet pipe 161 is provided on the side wall of the housing 11, and the first end of the L-shaped water inlet pipe 161 is configured to pass through the housing 11 to communicate with the top of the closed interlayer 12, and the height of the second end of the L-shaped water inlet pipe 161 is higher than the height of the top of the closed interlayer 12.

According to the embodiment of the present application, a funnel 163 is connected to the second end of the L-shaped water inlet pipe 161, and the funnel 163 is configured for water intake.

According to the embodiment of the present application, a water inlet valve 162 is connected between the funnel 163 and the second end of the L-shaped water inlet pipe 161.

According to the embodiment of the present application, a water outlet pipe 152 is provided on the side wall of the housing 11, the first end of the water outlet pipe 152 is connected to the closed interlayer 12, and the water outlet pipe 152 is provided with a drain valve 151, the second end of the water outlet pipe 152 is configured to protrude, and the height of the second end of the water outlet pipe 152 is lower than the height of the first end of the water outlet pipe 152.

According to the embodiment of the present application, the height of the first end of the water outlet pipe 152 is lower than the bottom surface of the liner 13.

According to the embodiment of the present application, the side wall of the housing 11 is further provided with an interface 111, the interface 111 is configured to electrically connect with the heating tube 115, and the interface 111 is configured to connect a power source to supply power to the heating tube 115.

According to the embodiment of the present application, the bottom of the housing 11 is provided with a plurality of feet 112.

Referring to FIG. 13 and FIG. 14, in another embodiment, the contour of the housing 11 is circular, and the higher the height of the housing 11 is, the larger the area of the contour is, and the contour of the liner 13 is circular.

Referring to FIG. 15, in another embodiment, the contour of the housing 11 is square, and the contour of the liner 13 is circular.

Referring to FIG. 16, in another embodiment, the contour of the housing 11 is a pentagon, and the contour of the liner 13 is circular.

Referring to FIG. 17, in another embodiment, t the contour of the housing 11 is hexagonal, and the contour of the liner 13 is circular.

Referring to FIG. 18, in another embodiment, the contour of the housing 11 is rectangle, and the contour of the liner 13 is circular.

Referring to FIG. 19, in another embodiment, the contour of the housing 11 is circular, and the contour of the liner 13 is circular.

In the wax heater according to the present application, the wax heater comprising a housing, a wax guiding tube and a liner located within the housing. A closed interlayer is formed between the housing and the liner, the top of the liner is provided with an opening, and the liner is configured to contain solid wax; the closed interlayer is provided with a heating tube, the closed interlayer contains an insulating liquid, the heating tube is configured to heat the insulating liquid in the closed interlayer to boiling point, the boiling point of the insulating liquid is higher than the melting point of the solid wax; one end of the wax guide tube is connected to the liner, the other end of the wax guide tube passes through the closed interlayer and the housing and extends outside the housing; after the solid wax is melted, it flows out of the wax heater through the wax guide tube. When the wax heater is working, the heating tube heats the insulating liquid to heat the liner. When the temperature in the liner exceeds 60° C. of the melting point of the solid wax, the solid wax melts and flows out through the wax guiding tube. Since the closed interlayer surrounds the liner, the wax heater can uniformly heat the liner and improve the heating efficiency. When the temperature of the insulating liquid in the inner reaches the boiling point, it will not increase, so as to avoid the too high temperature affecting the quality of the wax. Since the wax guiding tube passes through the closed interlayer, during the wax discharge process, the temperature of the wax guiding tube will not drop below 60° C., and the liquid wax will not block the wax discharge port.

Further, one end of the wax guiding tube is communicated with the liner at the bottom of the liner, and the other end of the wax guiding tube is provided with a wax discharge valve, and the height of the wax discharge valve is lower than the bottom surface of the liner. The wax guide tube discharges wax from the bottom of the liner, and the position of the wax discharge valve is low, and the liquid wax can be completely discharged.

For scented candle manufacturers, keeping the temperature of wax liquid stable has always been a very important requirement. However, since the density of wax is less than that of water, the wax liquid formed by the melted wax is viscous and has poor fluidity. It will cause uneven heating. When using a traditional electric wax melter to heat and melt the wax, usually only a single surface of the wax can be heat-treated at a high temperature of 100-200° C., while the other surfaces are not uniformly heated, which makes it difficult to control the simultaneous heating of all surfaces of the wax within a constant temperature, resulting in uneven heating of the wax as a whole.

The application adopts the principle of water bath heating, which can simultaneously apply a constant temperature of 30 to 100° C. to the three surfaces of the wax, which increases the heating surface and keeps the temperature of the melted wax liquid at a stable temperature as a whole. According to a large number of experimental data, the temperature difference between the bottom layer and the surface layer of the wax liquid heated by the traditional electric wax heater is between 18° C., while the temperature difference between the bottom layer and the surface layer of the wax liquid heated by the water bath wax heater is 4° C. It can be regarded as keeping the wax liquid at a constant temperature. This remarkable effect greatly improves the quality and efficiency in the process of making scented candles.

The above are only the preferred embodiments of the present application, and are not intended to limit the present application. Therefore, any modification, equivalent replacement, improvement, etc. made to the above embodiments according to the technical practice of the present application still fall within the scope of the technical solution of the present application.

What is claimed is:

1. A wax heater, wherein the wax heater comprises a housing, a wax guiding tube and a liner located within the housing, a closed interlayer is formed between the housing and the liner, the top of the liner is provided with an opening, and the liner is configured to contain solid wax;
the closed interlayer is provided with a heating tube, the closed interlayer contains an insulating liquid, the heating tube is configured to heat the insulating liquid in the closed interlayer to boiling point, the boiling point of the insulating liquid is higher than the melting point of the solid wax;
one end of the wax guide tube is connected to the liner, the other end of the wax guide tube is configured to pass through the closed interlayer and the housing and to extend outside the housing;
after the solid wax is melted, it flows out of the wax heater through the wax guiding pipe.

2. The wax heater according to claim 1, wherein one end of the wax guiding tube is configured to communicate with the liner at the bottom of the liner, and the other end of the wax guiding tube is provided with a wax discharger valve, the height of the wax discharge valve is lower than the bottom surface of the liner.

3. The wax heater according to claim 1, wherein an upper cover is provided on the top of the liner, and the upper cover is configured to cover the opening.

4. The wax heater according to claim 1, wherein an L-shaped water inlet pipe is provided on the side wall of the housing, and the first end of the L-shaped water inlet pipe is configured to pass through the housing to communicate with the top of the closed interlayer, and the height of the second end of the L-shaped water inlet pipe is higher than the height of the top of the closed interlayer.

5. The wax heater according to claim 4, wherein a funnel is connected to the second end of the L-shaped water inlet pipe, and the funnel is configured for water intake.

6. The wax heater according to claim 5, wherein a water inlet valve is connected between the funnel and the second end of the L-shaped water inlet pipe.

7. The wax heater according to claim 4, wherein a water outlet pipe is provided on the side wall of the housing, the first end of the water outlet pipe is connected to the closed interlayer, and the water outlet pipe is provided with a drain valve, the second end of the water outlet pipe is configured to protrude, and the height of the second end of the water outlet pipe is lower than the height of the first end of the water outlet pipe.

8. The wax heater according to claim 7, wherein the height of the first end of the water outlet pipe is lower than the bottom surface of the liner.

9. The wax heater according to claim 1, wherein the side wall of the housing is further provided with an interface, the interface is configured to electrically connect with the heating tube, and the interface is configured to connect a power source to supply power to the heating tube.

10. The wax heater according to claim 1, wherein the bottom of the housing is provided with a plurality of feet.
